(19) United States
(12) Patent Application Publication
(10) Pub. No.: US 2020/0229570 A1
(43) Pub. Date: Jul. 23, 2020

(54) Illuminated Purse Assembly

(71) Applicant: Jennifer Mitchell, Phoenix, AZ (US)

(72) Inventor: Jennifer Mitchell, Phoenix, AZ (US)

(21) Appl. No.: 16/253,810

(22) Filed: Jan. 22, 2019

(51) Int. Cl. A45C 15/06; F21V 23/04; F21L 4/08; H05B 37/02; A45C 3/06

(52) U.S. Cl. CPC A45C 15/06; F21V 23/0464; F21Y 2115/10; H05B 37/0281; A45C 3/06; F21L 4/08

(57) ABSTRACT

An illuminated purse assembly includes a purse for carrying objects. A set of first light emitters is each positioned within an interior of the purse to illuminate the interior of the purse. A set of second light emitters is each positioned within an interior of the purse to illuminate the interior of the purse. A light sensor is positioned within the purse to sense light when the purse is opened. The light sensor turns on each of the first and second light emitters when the light sensor senses light. An electronic timer is coupled to the purse and the electronic timer counts down an operation duration of time when the light sensor senses light. Each of the first and second light emitters is turned off when the operation duration of time elapses.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to purse devices and more particularly pertains to a new purse device for illuminating an interior of a purse when the purse is opened.

### BRIEF SUMMARY OF THE INVENTION

An embodiment of the disclosure meets the needs presented above by generally comprising a purse for carrying objects. A set of first light emitters is each positioned within an interior of the purse to illuminate the interior of the purse. A set of second light emitters is each positioned within an interior of the purse to illuminate the interior of the purse. A light sensor is positioned within the purse to sense light when the purse is opened. The light sensor turns on each of the first and second light emitters when the light sensor senses light. An electronic timer is coupled to the purse and the electronic timer counts down an operation duration of time when the light sensor senses light. Each of the first and second light emitters is turned off when the operation duration of time elapses.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an illuminated purse assembly according to an embodiment of the disclosure.

FIG. 2 is a cross sectional view taken along line 2-2 of FIG. 1 of an embodiment of the disclosure.

FIG. 3 is a right side phantom view of an embodiment of the disclosure.

### DETAILED DESCRIPTION OF THE INVENTION

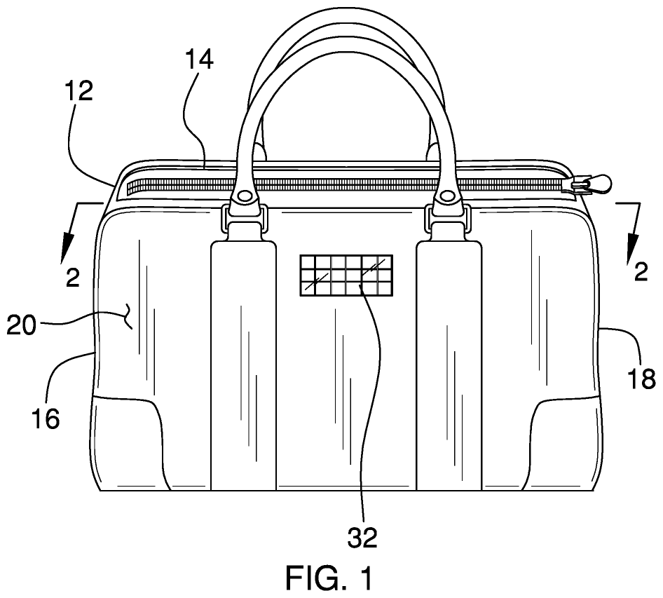

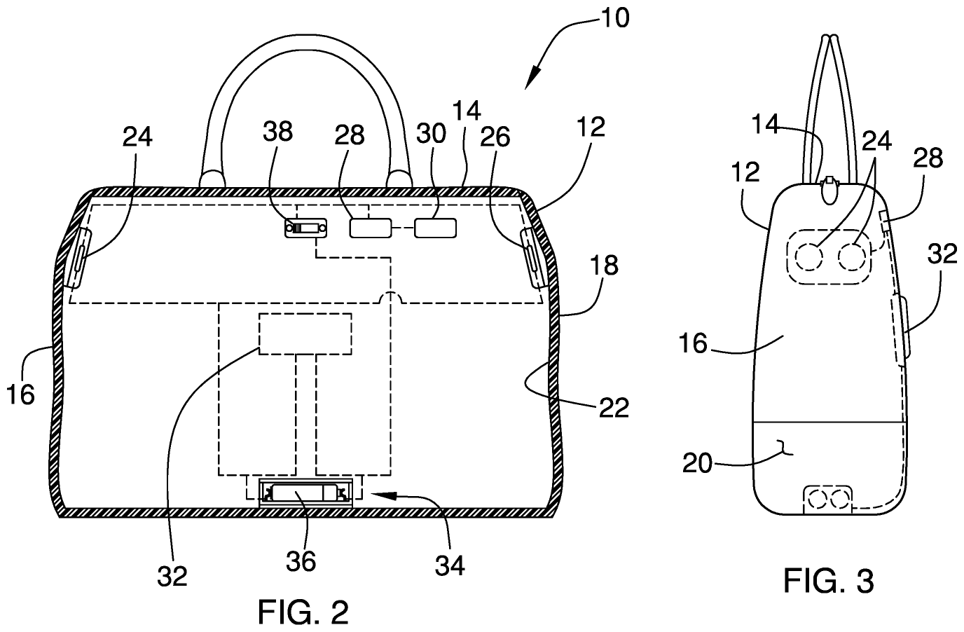

With reference now to the drawings, and in particular to FIGS. 1 through 3 thereof, a new purse device embodying the principles and concepts of an embodiment of the disclosure and generally designated by the reference numeral 10 will be described.

As best illustrated in FIGS. 1 through 3, the illuminated purse assembly 10 generally comprises a purse 12 that has a top end 14, a first lateral side 16, a second lateral side 18, an outer surface 20 and an inner surface 22. The top end 14 is open for insertably receiving cargo. The purse 12 may be structured in the convention of any existing purse, and the purse 12 may include handles, zippers, fasteners and any other accessories common to purses.

A set of first light emitters 24 is each coupled to the purse 12 and each of the first light emitters 24 is positioned within an interior of the purse 12 to illuminate the interior of the purse 12. Each of the first light emitters 24 is positioned on the inner surface 22 of the first lateral side 16 of the purse 12 and each of the first light emitters 24 is positioned adjacent to the top end 14 of the purse 12. A set of second light emitters 26 is each of the second light emitters 26 is coupled to the purse 12 and each of the second light emitters 26 is positioned within an interior of the purse 12 to illuminate the interior of the purse 12. Each of the second light emitters 26 is positioned on the inner surface 22 of the second lateral side 18 of the purse 12 and each of the second light emitters 26 is positioned adjacent to the top end 14 of the purse 12. Each of the first 24 and second 26 light emitters may comprise an LED or the like.

A light sensor 28 is positioned within the purse 12 and the light sensor 28 senses light when the purse 12 is opened. The light sensor 28 is electrically coupled to each of the first 24 and second 26 light emitters. Moreover, the light sensor 28 turns on each of the first 24 and second 26 light emitters when the light sensor 28 senses light. The light sensor 28 is positioned on the inner surface 22 of the purse 12 and the light sensor 28 may comprise an electronic light sensor 28 or the like.

An electronic timer 30 is coupled to the purse 12 and the electronic timer 30 is electrically coupled to each of the first 24 and second 26 light emitters and the light sensor 28. The electronic timer 30 counts down an operation duration of time and the electronic timer 30 is turned on when the light sensor 28 senses light. The electronic timer 30 begins counting down the operation duration of time when the electronic timer 30 is turned on. Additionally, each of the first 24 and second 26 light emitters is turned off when the operation duration of time elapses. The operation duration of time may range between approximately 15.0 seconds and 20.0 seconds.

A solar panel 32 is coupled to the purse 12 such that the solar panel 32 is exposed to sunlight. The solar panel 32 is positioned on the outer surface 20 of the purse 12 and the solar panel 32 may be a solar panel 32 of any conventional design. A power supply 34 provided and the power supply 34 is positioned within the purse 12. The power supply 34 is electrically coupled to each of the light sensor 28, the electronic timer 30, the set of first light emitters 24 and the set of second light emitters 26. The power supply 34 comprises at least one battery 36, and the at least one battery 36 is electrically coupled to the solar panel 32 such that the solar panel 32 charges the at least one battery 36.

A switch 38 may slidably coupled to the outer surface 20 of the purse 12. The switch 38 may be electrically coupled to each of the set of first light emitters 24 and the set of second light emitters 26. The switch 38 may be positionable in an on position for turning on each of the first 24 and second 26 light emitters. Additionally, the switch 38 may be positionable in an off position for turning each of the first 24 and second 26 light emitters off. The switch 36 may be a two position switch of any conventional design.

In use, the purse 12 is employed to carry objects in the typical convention of employing purses. The light sensor 28 senses light when the top end 14 of the purse 12 is opened to access the interior of the purse 12. Thus, each of the first 24 and second 26 light emitters are turned on to illuminate the interior of the purse 12 thereby enhancing objects to be located in the purse 12. Additionally, the electronic timer 30 begins counting down the operation duration of time when the light sensor 28 senses light. Each of the first 24 and second 26 light emitters is turned off when the operation duration of time elapses. Additionally, the solar panel 32 charges the at least one battery 36 when the solar panel 32 is exposed to sunlight.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An illuminated purse assembly being configured to illuminate an interior of said purse when said purse is opened, said assembly comprising:
a purse, said purse having a top end, a first lateral side, a second lateral side, an outer surface and an inner surface, said top end being open for insertably receiving cargo, said inner surface tapering approaching said top end;
a set of first light emitters, each of said first light emitters being positioned within an interior of said purse wherein each of said first light emitters is configured to illuminate said interior of said purse when said first light emitters are turned on, each of said first light emitters being positioned on said inner surface of said first lateral side of said purse laterally spaced and equidistant from said top end such that said first light emitters are horizontally parallel within said purse, each of said first light emitters being positioned adjacent to said top end of said purse wherein said set of first light emitters is angled to be directed downwardly into said purse;
a set of second light emitters, each of said second light emitters being positioned within an interior of said purse wherein each of said second light emitters is configured to illuminate said interior of said purse when said second light emitters are turned on, each of said second light emitters being positioned on said inner surface of said second lateral side of said purse laterally spaced and equidistant from said top end such that said second light emitters are horizontally parallel within said purse, said first light emitters and said second light emitters being equally spaced from said top end, each of said second light emitters being positioned adjacent to said top end of said purse wherein said set of second light emitters is angled to be directed downwardly into said purse;
a light sensor being positioned within said purse wherein said light sensor is configured to sense light when said purse is opened, said light sensor being electrically coupled to each of said first and second light emitters, said light sensor turning on each of said first and second light emitters when said light sensor senses light; and
an electronic timer being coupled to said purse, said electronic timer being electrically coupled to each of said first and second light emitters and said light sensor, said electronic timer counting down an operation duration of time, said electronic timer being turned on when said light sensor senses light, said electronic timer beginning counting down said operation duration of time when said electronic timer is turned on, each of said first and second light emitters being turned off when said operation duration of time elapses.

2. (canceled)

3. The assembly according to claim 1, further comprising a solar panel being coupled to said purse wherein said solar panel is configured to be exposed to sunlight, said solar panel being positioned on said outer surface of said purse.

4. The assembly according to claim 3, further comprising a power supply being positioned within said purse, said power supply being electrically coupled to each of said light sensor, said electronic timer, said set of first light emitter and said set of second light emitters, said power supply comprising at least one battery, said at least one battery being electrically coupled to said solar panel such that said solar panel charges said at least one battery.

5. An illuminated purse assembly being configured to illuminate an interior of said purse when said purse is opened, said assembly comprising:
a purse having a top end, a first lateral side, a second lateral side, an outer surface and an inner surface, said top end being open for insertably receiving cargo, said inner surface tapering approaching said top end;
a set of first light emitters, each of said first light emitters being coupled to said purse, each of said first light emitters being positioned within an interior of said purse wherein each of said first light emitters is configured to illuminate said interior of said purse when said first light emitters are turned on, each of said first light emitters being positioned on said inner surface of said first lateral side of said purse laterally spaced and equidistant from said top end such that said first light emitters are horizontally parallel within said purse, each of said first light emitters being positioned adjacent to said top end of said purse wherein said set of first light emitters is angled to be directed downwardly into said purse;
a set of second light emitters, each of said second light emitters being coupled to said purse, each of said second light emitters being positioned within an interior of said purse wherein each of said second light emitters is configured to illuminate said interior of said purse when said second light emitters are turned on, each of said second light emitters being positioned on said inner surface of said second lateral side of said purse laterally spaced and equidistant from said top end such that said second light emitters are horizontally parallel within said purse, said first light emitters and said second light emitters being equally spaced from said top end, each of said second light emitters being positioned adjacent to said top end of said purse wherein said set of second light emitters is angled to be directed downwardly into said purse;
a light sensor being positioned within said purse wherein said light sensor is configured to sense light when said purse is opened, said light sensor being electrically coupled to each of said first and second light emitters, said light sensor turning on each of said first and second light emitters when said light sensor senses light, said light sensor being positioned on said inside surface of said purse;
an electronic timer being coupled to said purse, said electronic timer being electrically coupled to each of said first and second light emitters and said light sensor, said electronic timer counting down an operation duration of time, said electronic timer being turned on when said light sensor senses light, said electronic timer beginning counting down said operation duration of time when said electronic timer is turned on, each of said first and second light emitters being turned off when said operation duration of time elapses;
a solar panel being coupled to said purse wherein said solar panel is configured to be exposed to sunlight, said solar panel being positioned on said outer surface of said purse; and
a power supply being positioned within said purse, said power supply being electrically coupled to each of said light sensor, said electronic timer, said set of first light emitter and said set of second light emitters, said power supply comprising at least one battery, said at least one battery being electrically coupled to said solar panel such that said solar panel charges said at least one battery.

6. The assembly according to claim 5, further comprising a switch being slidably coupled to said outer surface of said purse, said switch being electrically coupled to each of said set of first light emitters and said set of second light emitters, said switch being positionable in an on position for turning on each of said first and second light emitters, said switch being positionable in an off position for turning each of said first and second light emitters off.
